(19) United States
(12) Patent Application Publication
(10) Pub. No.: US 2008/0265455 A1
(43) Pub. Date: Oct. 30, 2008

(54) Injection Molding Process for Making Laboratory Test-Tubes and Mold to Be Used in the Molding Process Thereof

(75) Inventor: Renzo Chiarin, Padova (IT)

Correspondence Address: SHOEMAKER AND MATTARE, LTD, 10 POST OFFICE ROAD - SUITE 110, SILVER SPRING, MD, 20910, US

(73) Assignee: VACUTEST KIMA S.R.L., Arzergrande (Padova) (IT)

(21) Appl. No.: 11/910,782

(22) PCT Filed: Apr. 4, 2006
(86) PCT No.: PCT/IB06/00990

§ 371 Date: Nov. 6, 2007

(30) Foreign Application Priority Data
Apr. 6, 2005 (IT) PD2005A000091

(51) Int. Cl. B29C 45/34

(52) U.S. Cl. 264/102; 425/546

(57) ABSTRACT

Plastic material is injected into a chamber defined between a female mold member and a male mold member, while air is evacuated from the chamber. In the evacuation step, the air contained in the forming chamber progressively exits from the mold under the pressure of the melted plastic material through a multiplicity of slits made on the female element at different heights along the above-mentioned central axis. The slits have dimensions such as to allow the passage of the air and at the same time to block the flow of the melted plastic material from the forming chamber.

### FIELD OF THE INVENTION

The present invention refers to a process for the injection moulding of plastic materials to make laboratory test tubes and to a mould usable in such process.

The moulding process and the mould subject of the present invention can be advantageously used in producing test tubes, pipettes and like plastic containers generally for clinical use, and more particularly adapted for use in clinical tests to measure a blood sample's erythrocyte sedimentation rate (ESR).

### BACKGROUND OF THE INVENTION

As is known, in the field of chemical analysis of body fluids, particularly by means of automatic analytical tools, there exists the particular need to have test tubes, pipettes or other like containers with containment side walls which are perfectly aligned with the longitudinal extension axis of the test tube itself and have a constant thickness along the entire axis.

This need is particularly important, for example, in the tests for measuring a blood sample's erythrocyte sedimentation rate (ESR). As is known, in fact, the erythrocyte sedimentation process is strongly influenced by the shape of the side walls of the test tube which is used to contain the blood sample to be analysed. In fact, if the test tube has an internal cross-section which is not perfectly constant and, thus, internal walls not perfectly aligned relative to its longitudinal extension axis, the erythrocytes inevitably tend to deposit themselves on the internal walls of the test tube itself, thus slowing their sedimentation movement toward the bottom. The ESR values obtained from measurements carried out in such test tubes shall result, therefore, misrepresented and unreliable. In the tests for measuring the ESR the need to have test tubes with side walls having a perfectly constant thickness is not connected per se to the process of erythrosedimentation, but to the appearance of optical type, automatic measuring tools. These tools are calibrated depending on the thickness of the test tube's side walls, since the measurement they give also depends on the optical path of the reading rays through the walls. Therefore, possible irregularities in the thickness of the walls, by modifying the optical path of the rays, can cause the automatic reading tool to provide measurement values outside the calibration range and therefore unreliable.

As is known, the current processes for the injection moulding of plastic materials do not allow for making laboratory test tubes which have all the constructive peculiarities stated above, that is perfectly vertical side walls and constant thickness along the entire longitudinal extension of the test tubes themselves. Therefore, traditionally, to produce such test tubes, glass has always been used, which, with respect to plastic materials, can be processed with operatively more flexible moulding processes and which is especially capable of providing final products with extreme dimensional tolerances.

The impossibility to use plastic materials in the production of this type of test tubes derives, firstly, from the operative difficulties encountered in keeping the male perfectly aligned and centred within the mould during the moulding process and, secondly, from the difficulties encountered in expelling air from the mould during the injection step of the molten plastic material.

More in detail, the difficulties of centering the male within the mould are a consequence of the fact that the dimensions of the male are bound to those of the test tubes to be made (internal diameter of about 6-7 mm, wall thickness of about 1 mm and length of about 11-12 cm). The male is particularly slender and therefore it is not sufficiently strong and rigid to stand the high moulding pressures requested (in the order of 100 bar) in the case of the moulding of plastic materials without undergoing bending relative to the central axis of the mould. This would inevitably lead to have plastic test tubes with inclined side walls and with non-constant thickness.

This problem is emphasized, moreover, by the fact that, in order to ease the expulsion of all the air present in the mould, the molten plastic material is injected in the mould preferably at the bottom of the test tube. In fact, with an injection from the bottom, the air is pushed toward the mouth of the test tube where it can easily come out without special air-expellers. Therefore, there is the advantage of having a mould which is constructively simple to make and operatively reliable. However, in this way, the injection pressures of higher intensity are exerted just at the free end of the male, that is in the area where the latter is less rigid and is more easily subject to bending.

To limit the bending of the male, the plastic material can be injected in the mould at the mouth or possibly along the longitudinal extension axis of the test tube. With this solution, the injection pressures are exerted in areas where the male is more rigid. However, the air contained inside the mould is pushed, at least partially, in the moulding area corresponding to the bottom of the test tube. Therefore, it necessary to provide, in the mould, a set of expellers to allow the evacuation of the air and prevent it from being trapped as bubbles inside the plastic matrix. In fact, considering the reduced thicknesses of the test tube's walls, the presence of air bubbles could generate micro pores capable of compromising the impermeability of the test tube, which would then become totally unusable.

From an operative point of view, this second solution requires therefore providing a constructively much more complicated mould compared to the one requested for the injection from the bottom. Moreover, this second solution, even though it partially solves the problem of the centering of the male, is quite unreliable. In fact, it is known in the art that the air expellers currently used are frequently obstructed and need a continuous maintenance which is particularly time consuming, which is unaffordable in large scale productions.

### SUMMARY OF THE INVENTION

In this situation, therefore, the object of the present invention is to eliminate the drawbacks of the above-mentioned known art, providing an injection moulding process that allows making laboratory test tubes in plastic material with improved characteristics.

A further object of the present invention is to provide a process for the injection moulding which allow making plastic test tubes with perfectly vertical side walls and with a constant thickness along their entire longitudinal extension.

Another object of the present invention is to provide a moulding process that is both cheap and easy to realize.

A further object of the present invention is to provide a mould usable in such moulding process that allows a perfect centering of the male and a complete expulsion of the air without using traditional expellers.

These and other aims are all reached using an injection moulding process and a mould usable in such process according to the appended claims.

### BRIEF DESCRIPTION OF THE DRAWINGS

The technical characteristics of the invention, according to the above-mentioned purposes, can be clearly checked from the content of the following claims and the advantages of the same will be more evident in the detailed description which follows, made in reference to the drawings attached, which represent a merely illustrative and not limiting embodiment thereof, wherein:

FIG. 1 shows a side schematic view of a forming mould according to the invention;

FIG. 2 shows a perspective view of a detail of the mould of FIG. 1 concerning the extension of slits for the evacuation of the air according to a preferred embodiment;

FIGS. 3 and 3a show a plan view of a detail of the mould of FIG. 1 concerning first support base;

FIG. 4 shows a section view of the first support base of FIG. 3 along the line IV-IV of the same figure;

FIG. 5 shows a perspective view of the first support base of FIG. 4 sectioned along line V-V of FIG. 4;

FIGS. 6 and 6a show a plan view of a detail of the mould of FIG. 1 related to a second support base;

FIG. 7 shows a section view of the second support base of FIG. 6 according to the line VII-VII of the same figure;

FIG. 8 shows a perspective view of the second support base of FIG. 6 sectioned along the line VIII-VIII of FIG. 7;

FIG. 9 shows a perspective view of the first and of the second support base of FIGS. 5 and 8 in an assembled condition, with some parts removed to better highlight others; and

FIGS. 10 and 11 show two perspective views of a detail of the mould of FIG. 1 concerning the extension of slits for the evacuation of the air according to two different alternative embodiments.

### DETAILED DESCRIPTION OF THE INVENTION

The process for the injection moulding of plastic material, subject of the present invention, can be advantageously used in the production of laboratory test tubes, pipettes and like containers in plastic material, intended in general to clinical use, which require perfectly vertical side walls having a constant thickness along the entire longitudinal extension of the test tubes themselves.

In particular, this moulding process can, therefore, be employed in the production laboratory test tubes in plastic material suitable to be employed in clinical tests to measure a blood sample's erythrocyte sedimentation rate (ESR). Furthermore, the moulding process, subject of the present invention, allows solving the problem of evacuating the air from the mould without having to use traditional type expellers.

Advantageously, this moulding process can use any plastic material suitable for medical use such as, for example, polyethylene terephthalate (PET), polyethylene (PE), polypropylene (PP), polyvinyl chloride (PVC), polystyrene, and methacrylate.

The first operative step of the process according to the present invention is a step of providing at least one shaped mould 1 for the forming of a laboratory test tube.

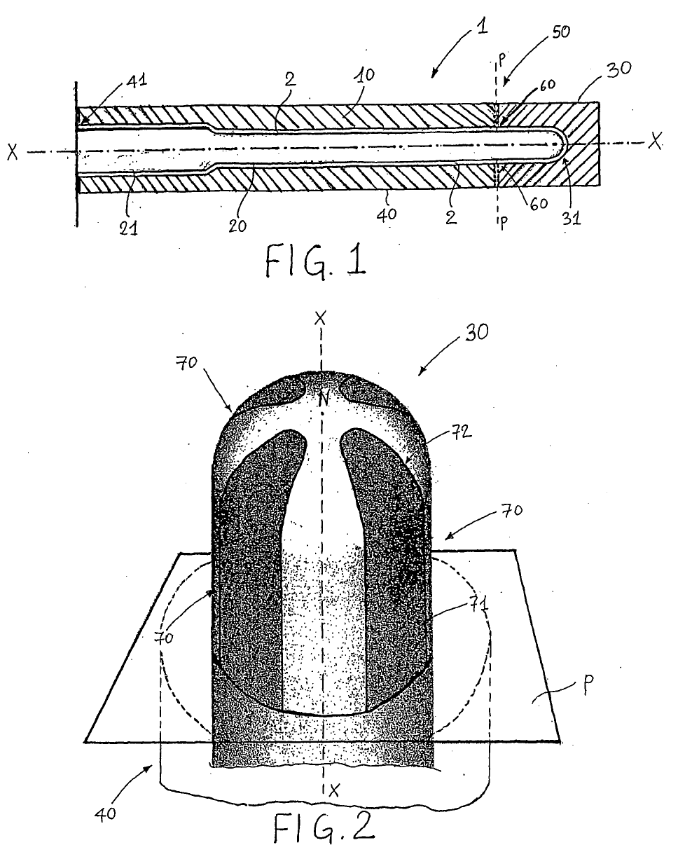

This mould 1 includes a female element 10 internally hollow and a male element 20 insertable inside the female element 10 to define a suitable forming chamber 2 for a laboratory test tube. As it can be seen in FIG. 1, this forming chamber 2 has a main longitudinal extension along a central axis X. The shape of the forming chamber 2 can be of any type, depending on the needs.

As will be explained further in detail, describing the mould which is subject of present invention, together with the moulding process, the female element 10 includes at least a bottom portion 30, intended to shape the bottom of the test tube, and a head portion 40, intended to shape the main body of the test-tube itself.

More in detail, the bottom portion 30 includes a substantially hemispherical cap 31, while the head portion 40 is provided with an inlet mouth 41, which corresponds to the mouth itself of the test-tube, to allow the insertion of the male element 20.

Following the above-said step of providing the mould, it is foreseen a step of inserting the male element 20 inside the female element 10 along the above-mentioned central axis X.

At this point, the forming chamber 2 is prepared and it is possible then to proceed with an injection step of molten plastic material inside mould 1. In this step, the plastic material, previously melted in an appropriate melting chamber is introduced under pressure in the forming chamber 2 by means of a plurality of injection points 60 made on the female element 10. The melted plastic material fills progressively the forming chamber 2 in a subsequent filling step.

According to an important aspect of the present invention, simultaneously to this filling step, it is foreseen a step of evacuation for the air contained in the forming chamber 2. During this step, the air comes out progressively from the mould 1 through a plurality of slits 70 made on the female element 10 under the pressure of the molten plastic material that progressively fills the forming chamber 2.

As will be further described in detail, these slits 70 have dimensions such as to allow the airflow and to block, at the same time, the emission of molten plastic material from the forming chamber 2. Such slits 70 are provided at different heights along the above-mentioned central axis X, so as to allow a progressive airflow of the air from the mould as the molten plastic material fills the forming chamber 2.

After the solidification of the plastic material, it is foreseen an extraction step of the male element 20 from the female element 10 and, therefore, a removal step of the test tube from the mould 1.

Advantageously, during the above-mentioned injection step, the melted plastic material is introduced under pressure inside the forming chamber 2 through side injection points 60. The various side injection points 60 are made in the female element 10 in a intermediate section 50 comprised between the inlet mouth 41 and the bottom portion 30 and can be coplanar lying on a same plane p substantially orthogonal relative to the above-mentioned central axis X, or they can lie on more parallel planes p substantially orthogonal relative to the above-mentioned central axis X. Preferably, the injection points 60 are made between the bottom portion 30 and the head portion 40. According to a first embodiment, the side injection points 60 are made as pairs of opposite points with respect to the central axis X. Each pair's injection points lie substantially on the same orthogonal plane p. Preferably, all the injection points are made on the same orthogonal plane p.

According to a second embodiment, the side injection points 60 are radially distributed with respect to the central axis X at regular angular distances. For example, 3 injection points can be provided, mutually distributed with an angular distance of about 120°.

Preferably, the side injection points 60, irrespective of how they are distributed inside the female element 10, are defined by nozzles orthogonally oriented with respect to said central axis X, to allow the molten plastic material to enter under pressure the forming chamber 2 during the injection step according to injection directions Y orthogonal relative to the central axis X. Thanks to this distribution of the nozzles, the male element 20 is subjected to an overall balanced system of forces which provides for a perfect centering of the male element 20 itself along the above-mentioned central axis X during the moulding of the test tube.

In accordance with alternative embodiments, the centering of the male element 20 can also be obtained by orienting the nozzles of the side injection points 60 at angles which are non-right with respect to the central axis X. In this case, the nozzles are not coplanar with the plans p in which the various injection points 60 lie, but they lie on inclined planes. These alternative solutions, however, even though they allow centering of the male, have the disadvantage of originating a not perfectly homogenous injection of the melted plastic material inside the forming chamber 2.

Advantageously, thanks to the above-mentioned even distribution of the injection points 60, either equidistanced or in pairs of opposed points, during the filling step, the male element 20 is kept centred inside of the female element 10 and aligned to the central axis X of the forming chamber 2 by the uniformly distributed pressure of the melted plastic material introduced inside the forming chamber 2 through the above-mentioned injection points 60.

Advantageously, the above-mentioned slits 70 can extend themselves for the entire longitudinal extension of the female element 20 along the central axis X as well as limit themselves to some segments, provided that at least the bottom portion 30 is covered.

In fact, during the evacuation step, the air contained inside the forming chamber 2 in the segment comprised between the inlet mouth 41 and the intermediate section 50 in which the injection points 60 are made, tends naturally to come out from the mould 1 at the inlet mouth itself. Therefore, in this segment of the forming chamber 2 the slits 70, though facilitating the evacuation of the air, can also not be present. On the other hand, the air contained inside the forming chamber 2, in the segment comprised between the above-mentioned intermediate section 50 and the bottom portion 30, cannot come out from the inlet mouth 41, the passage being obstructed by the melted plastic material, and has as a single escape route only the slits 70.

In accordance with a preferred embodiment, each of the above-mentioned slits 70 extends with a first segment 71 starting from the intermediate section 50 in which the injection points 60 are made, to proceed then with a second segment 72 in the cap 31 of the bottom portion 30. Preferably, the first segment 71 is substantially rectilinear and parallel to the central axis X and continuously connects with the second segment 72, which is substantially curvilinear and converging toward the N pole of the cap 31, to form a continuous slit.

In accordance with an alternative embodiment not illustrated in the attached figures, each slit 70 can have a substantially circular form, coaxial to the central axis X. The slits lie on several parallel planes located at different heights relative to the central axis X starting form the cap 31 toward the inlet mouth 41 to get at least near the intermediate section 50 where the injection points 60 are made.

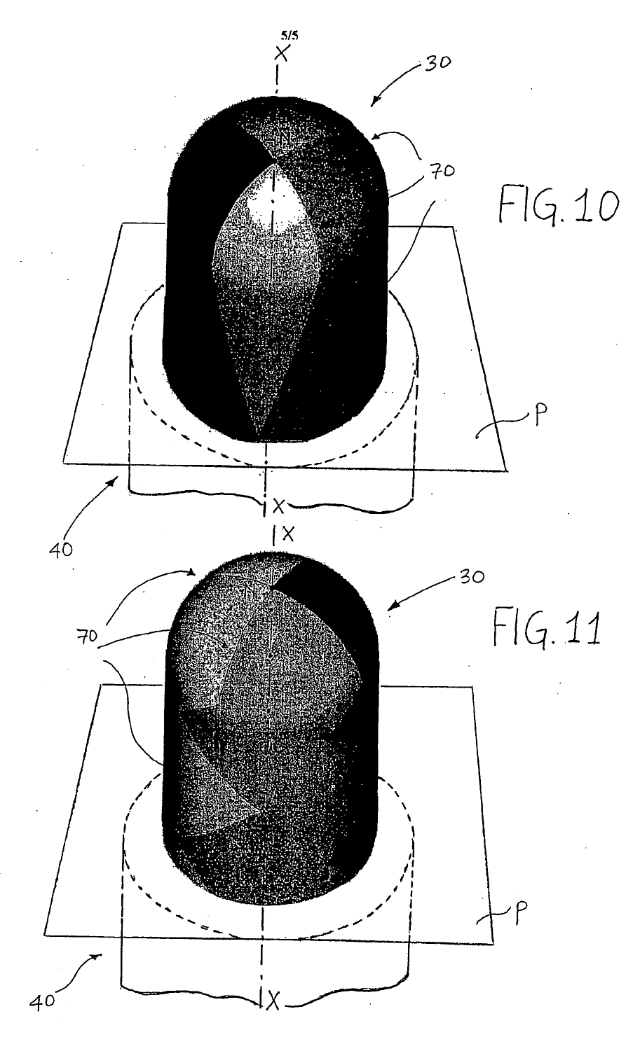

The protective scope of this patent is not limited to the shapes of the slits 70 just described, but it extends to any shape useful to carry out the role of these slits 70, that is to progressively expel the air during the filling step of the mould 1. In fact, for example, there can be foreseen slits 70 which intersect, which follow a broken or inclined line with respect to the central axis X or which have a wavy pattern. In FIGS. 10 and 11 some alternative solutions are shown for the forming of the slits 70, with oblique lines and broken lines, respectively.

As already mentioned before, also an object of the present invention is a mould for the forming of laboratory test tubes by injection of plastic material, usable especially in the moulding process just described.

The basic characteristics of this mould have already been anticipated by describing the moulding process, subject of the present invention. With reference to the attached figures, a preferred embodiment of such mould will be described, therefore, keeping the numeral references already used before.

As it can be observed in FIG. 1, the male element 20 of the mould 1, consists of a tubular body having a main longitudinal extension along the above-mentioned central axis X. The male element 20 is connected to a first support structure (not shown) at its base portion 21. Preferably, at this base portion 21, the male element 20 shows an increased cross-section such that the bending resistance along the central axis is increased.

The female element 10 is housed inside a second support structure (not shown) inside of which a series of heated injection channels 80 are made, which communicate with the side injection points 60 to convey the melted plastic material from one melting chamber (not shown) to the forming chamber 2.

More in detail, the female element 10 consists of two distinct hollow bodies, which are assembled before the moulding to define the test tube's external extension surface. A first hollow body corresponds to the above-mentioned head portion 40 and defines the shape of the test tube for the segment extending from the mouth of the test tube itself to the end of the graduated area, while the second hollow body corresponds to the above-mentioned bottom portion 30 and defines the shape of the test tube for the segment extending from the end of the graduated area to the bottom.

As it can be seen in FIG. 1 the interface area between these two hollow bodies 30 and 40 of the female element 10 defines the above-mentioned intermediate section 50 where the side injection points 60 lie and is defined by a plane p orthogonal to the central axis X. Preferably, this plane p is located immediately below the test tube's graduated reading area so to avoid that the graduated area is deteriorated by the presence of the traces of the injection points.

As already mentioned before, according to alternative solutions not shown, the injection points 60 can lie on different planes orthogonal to the central axis X. In this case, the interface area between these two hollow bodies 30 and 40 of the female element 10 is no longer a single substantially flat surface but it is rather a surface with steps (straight or ramp shaped) defined by the various orthogonal plans to the central axis X (parallel to each other) in which the injection points lie.

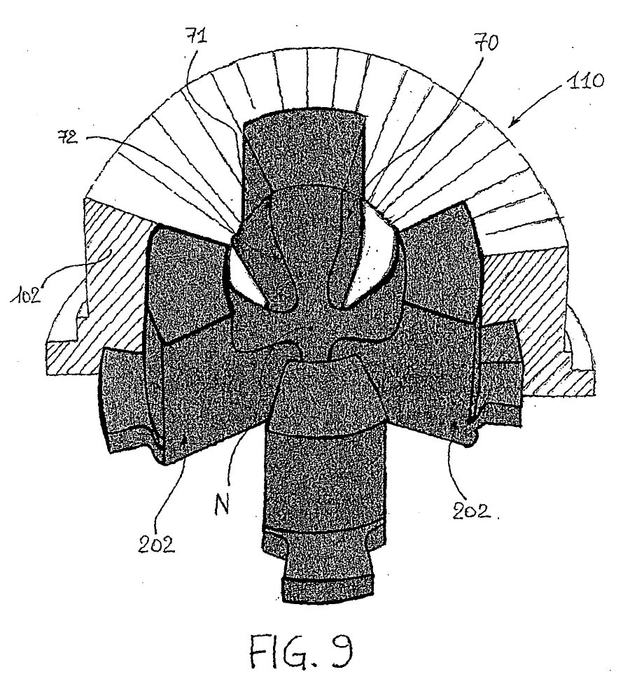

In accordance with the preferred embodiment shown, particularly in FIGS. 5 and 8, the bottom portion 30 of the female element 10 is formed by a first and a second series of sections 100 and 200, which are connected to a first and a second support base 110 and 210, respectively. These bases, analogously to the two series of sections, are suitably shaped so to be mutually fit coupled thus forming a single body. As it can be observed in FIG. 9, when the two support bases 110 and 210 are coupled, the sections 100 of the first series alternate with the sections 200 of the second series.

As it can be observed in particular in FIGS. 4 and 5, the first support base 110 consists of a cylindrical body, which is coaxially provided with an internal shaped cavity 111. Inside this cavity 11, four sections 100, having a main longitudinal extension parallel to the central axis X, radially project. Each section is shaped so as to show a concave part 103, which defines the corresponding sector of the hemispherical cap 31 and converges toward the latter's N pole, and a substantially flat part 104, which extends parallel to the central axis X up to the orthogonal plane p wherein the injection points 60 lie, to define the corresponding sector of the bottom portion 30 which connects to the head portion 40.

As can be observed in FIG. 8, the second support base 210 consists of a flat body 213 from where four arms 212 project radially at 90°. From each arm a section 200 extends parallel to the central axis X. The four sections 200 connect to each other at the pole N of the hemispherical cap 31. The shape of the sections 200 of the second series is substantially similar to the one of the sections 100 of the first series.

The interface surfaces between the sections of the two series 100 and 200 define the slits 70 for the evacuation of the air. Preferably, each slit 70 extends transversally to the central axis X with an air gap L comprised in the range between 0.005 and 0.02 mm and is defined by two opposite flat walls 102 and 202, belonging to two sections of the two series 100 and 200 respectively. Preferably, these walls have a surface roughness defined as Ra in the range between 0.4 10-6 m and 6.3 10-6 m. This surface roughness defines, between the two walls, a thick network of micro channels that allow the free passing of the air, though preventing, at the same time, the leaking of melted plastic material.

In accordance with this preferred embodiment, there are eight slits 70 for the evacuation of the air which follow the profile of the sections of the two series 100 and 200. The first segment 71 of each slit follows the edge of the flat part 104 of the sections, while the second segment 72 follows the edge of the concave part 103 of the sections. The extension of these slits 70 can be appreciated in the FIG. 2, wherein for the sake of clarity, only the surface extension of the bottom portion 30 is shown without illustrating the real thickness of the external containment walls.

The overall extension of the slits 70 thus defined, allows to obtain large active evacuation surfaces and difficult to obtain by using, instead, traditional type expellers. In fact, for a mould 1 according to the invention in which the distance between the pole N of the cap 31 and the plane p of the injection points has been established to be equal to about 15 mm, the overall evacuation surface provided by the 8 slits is 2.4 mm², considering, for each slit, an air gap L of 0.02 mm. This surface is equal to the one of a circular hole having a diameter of about 1.76 mm.

Traditionally, an evacuation surface of these sizes can be realised only by providing in the bottom of the mould a high (and constructively impossible) number of expellers, with the disadvantage of not having a distributed evacuation surface, but a surface in any case concentrated in a few points.

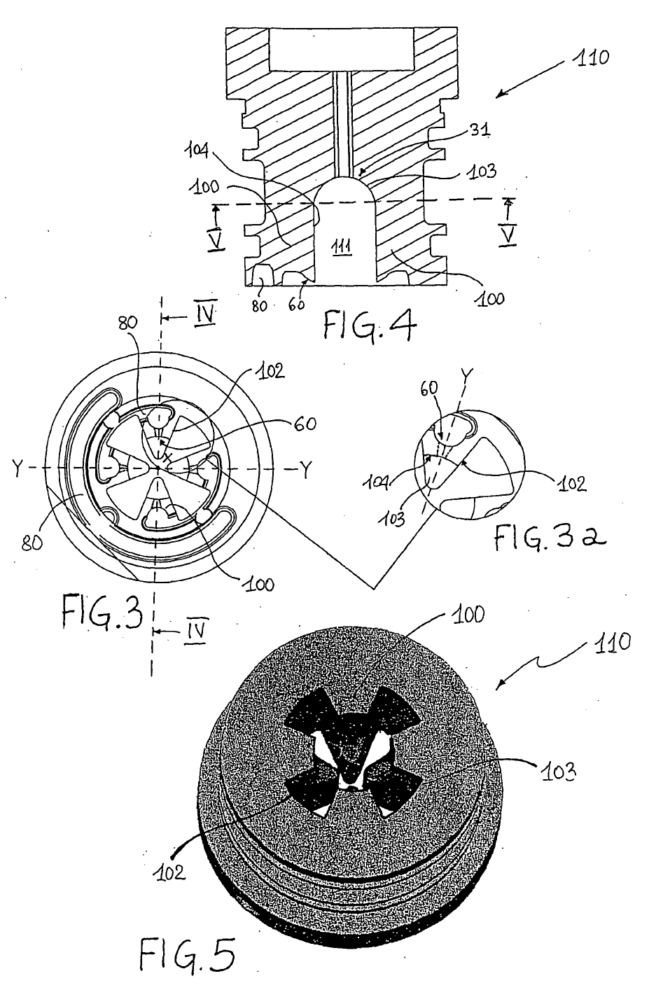

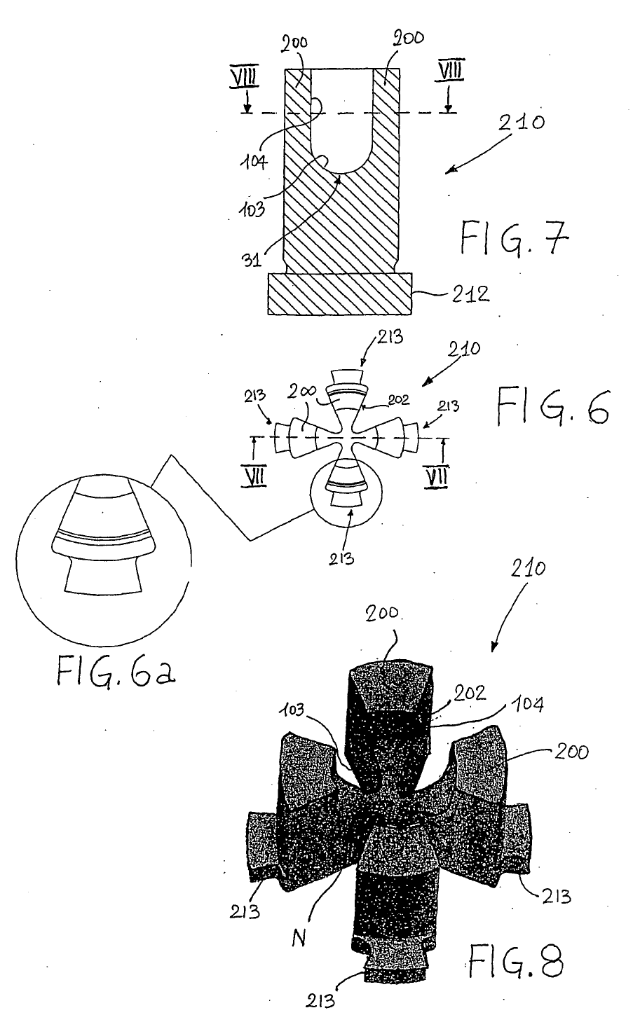

As it can be observed in detail in the FIGS. 3 and 3a, the injection points 60 are made in the first support base 110, at each of the sections 100 of the first series. The injection points 60 are four, radially arranged relative to the central axis X and spaced angularly at 90° the one from the other so as to result opposite in pairs. The injection points 60 are defined by nozzles orthogonally oriented relative to the central axis X to allow the plastic material to enter the forming chamber 2 according to directions Y of injection orthogonal to the central axis X and to allow, thus, the centering of the male element 20 inside the female element 10.

More in detail, as can be observed in FIG. 3, the melted plastic material is conveyed to the various nozzles through a network of injection channels 80 which branch out from a delivery collector (not illustrated) by means of a series of bifurcations. This constructive solution allows the achievement of a balanced injection thus obtaining the same injection pressure in each nozzle.

1-25. (canceled)

26. Injection molding process for making laboratory test tubes from a plastic material comprising the following operating steps:
prearranging at least one mold which defines, by means of an external female element and an internal male element, a forming chamber for a test tube, said chamber having a main longitudinal extension along a second central axis, said female element comprising a bottom portion and a head portion inside of which an inlet mouth is made for said male element;
inserting said male element inside said female element along said central axis;
injecting melted plastic material under pressure into said forming chamber through a multiplicity of injection points provided on said female element;
progressively filling said molding chamber with said plastic material to obtain said test tube; while simultaneously evacuating air contained in said forming chamber progressively from said mold under the pressure of said plastic material through a plurality of slits made on said female element at different heights along said central axis, said slits having dimensions such to permit the passage of the air and at the same time to block flow of said melted plastic material from said forming chamber;
extracting said male element from said female element;
removing said test tube from said mold.

27. Molding process according to claim 26, wherein during said injection step said melted plastic material is introduced under pressure into said forming chamber through side injection points, which lie on one or more planes substantially orthogonal to said central axis in an intermediate section of said female element comprised between said inlet mouth and said bottom portion.

28. Molding process according to claim 27, wherein said side injection points are made between said bottom portion and said head portion.

29. Molding process according to claim 27, wherein said side injection points are made on said female element in pairs of opposite points with respect to said central axis, the two opposite injection points of each pair substantially lying on the same orthogonal plane.

30. Molding process according to claim 27, wherein said injection points are distributed radially with respect to said central axis at regular angular distances.

31. Molding process according to claim 27, wherein said side injection points are defined by nozzles oriented orthogonally with respect to said central axis to permit said melted plastic material during said injection phase to enter inside said forming chamber under pressure and along injection directions which are orthogonal with respect to said central axis.

32. Molding process according to claim 27, wherein said male element is kept centred inside said female element and aligned with respect to said central axis by said melted plastic material introduced under pressure inside said forming chamber through said side injection points.

33. Molding process according to claim 27, wherein each of said slits shows at least a first substantially rectilinear segment which is parallel to said central axis.

34. Molding process according to claim 33, wherein said bottom portion comprises a substantially hemispherical cap and wherein each of said slits extends at said cap with a second curvilinear segment converging towards the pole of said cap.

35. Molding process according to claim 27, wherein each of said slits extends beginning from the cap of said bottom portion with said second segment to proceed towards said inlet mouth with said first segment at least until near said intermediate section where said injection points are made, said second segment being continuously connected to said first segment to form a continuous slit.

36. Molding process according to claim 27, wherein each of said slits has a substantially circular form, coaxial with respect to said central axis, said slits lying on parallel planes placed at different heights with respect to said central axis starting from said cap towards said inlet mouth until arriving at least in proximity with said intermediate section.

37. Molding process according to claim 35, wherein during said evacuation step the air contained inside said forming chamber between said intermediate section and said inlet mouth exits said mold mainly at mouth, while the air contained inside the said forming chamber between said intermediate section and said cap progressively exits from said mold through said slits.

38. Molding process according to claim 26, wherein said plastic material is chosen in the group comprising polyethylene terephthalate (PET), polyethylene (PE), polypropylene (PP), polyvinyl chloride (PVC), polystyrene and methacrylate.

39. Mold for the forming of laboratory test tubes by means of injection of melted plastic material, usable in the molding process according to claim 26, said mold comprising:
a forming chamber defined by an external female element and an internal male element, said chamber having a main extension on a central axis, said female element being provided with several side injection points for said melted plastic material and comprising a bottom portion and a head portion, wherein an inlet mouth has been made for said male element;
a plurality of injection channels made on the female element outside said forming chamber, which communicate with said injection points to convey said melted plastic material from a melting chamber to said forming chamber;
wherein said female element is provided with a plurality of slits adapted to permit the exit of the air contained in the forming chamber under the pressure of the melted plastic material, said slits being arranged at different heights along said central axis and having dimensions such to permit the passage of the air and at the same time block the emission of said melted plastic material from said mold.

40. Mold according to claim 39, wherein each of said slits has a width between 0.005 and 0.02 mm and is defined by two opposite walls having a surface roughness defined as Ra comprised between 0.4×10⁻⁶ m and 6.3×10⁻⁶ m.

41. Mold according to claim 39, wherein said side injection points lie on one or more planes substantially orthogonal with respect to said central axis in an intermediate section of said female element comprised between said inlet mouth and said bottom portion.

42. Mold according to claim 41, wherein said side injection points are made from said bottom portion and said head portion.

43. Mold according to claim 41, wherein said side injection points are made on said female element as pairs of points, opposite with respect to said central axis, the two opposite injection points of each pair substantially lying on the same orthogonal plane.

44. Mold according to claim 41, wherein said injection points are arranged radially with respect to said central axis at regular angular distances.

45. Mold according to claim 39, wherein said injection points are defined by nozzles oriented orthogonally with respect to said central axis to permit said plastic material to enter inside said forming chamber along injection directions which are orthogonal to said central axis and thus to permit the centering of said male element inside said female element.

46. Mold according to claim 39, in which each of said slits extends between said bottom portion and said head portion with at least a first segment substantially rectilinear and parallel with respect to said central axis.

47. Mold according to claim 46, wherein said bottom portion comprises a substantially hemispherical cap and wherein each of said slits extends at said cap with a second curvilinear segment converging towards the pole of said cap.

48. Mold according to claim 41, wherein each of said slits extends starting from said cap with said second segment to proceed towards said inlet mouth with said first segment until at least in proximity with said intermediate section, said second segment being continuously connected to said first segment to form a continuous slit.

49. Mold according to claim 39, wherein each of said slits has a substantially circular form, coaxial with respect to said central axis, said slits lying on parallel planes placed at different heights with respect to said central axis beginning from said cap towards said inlet mouth.

50. Mold according to claim 39, wherein said bottom portion is formed by at least a first and a second series of sections connected respectively to a first and to a second counter-shaped support base to permit a mutual coupling, the sections of said first series alternating with said wedges of said second series, said slits being defined in the interface zones between the sections of said first series and the sections of said second series.
